(19) United States
(12) Patent Application Publication
(10) Pub. No.: US 2007/0170002 A1
(43) Pub. Date: Jul. 26, 2007

(54) Fork lift attachment, and methods

(76) Inventor: Richard Ziebell, Lake City, MN (US)

Correspondence Address: MERCHANT & GOULD PC, P.O. BOX 2903, MINNEAPOLIS, MN, 55402-0903, US

(21) Appl. No.: 11/340,294

(22) Filed: Jan. 26, 2006

(51) Int. Cl. B60R 19/44

(52) U.S. Cl. 187/237; 414/785; 293/142

(57) ABSTRACT

A guard for positioning on a fork for a fork lift or fork truck. The guard has a body configured to cover at least a portion of the bottom surface of the fork, with the body extending at least a portion of the length between the tip and the heel. An attachment mechanism for holding the body onto the fork is included. The attachment mechanism could be a pocket for receiving the tip of the fork, or a sleeve for passing the fork therethrough. The sleeve could encircle the fork. The body could extend the entire length of the fork from the top to the heel, and/or could extend around and engage the heel of the fork. The guard could be made from a polymeric material, and include metal, such as to increase the wear resistance.

### FIELD

The present invention relates to fork lift vehicles, particularly, to their forks. The present invention is a wear guard for the forks.

### BACKGROUND

Fork-lift trucks, also commonly referred to as fork-lifts or fork trucks, are a well known vehicle that is important in manufacturing and shipping industries. Without the fork-lift truck, lifting and moving of large items would be significantly more difficult.

A fork-lift truck or vehicle is illustrated in FIG. 1. The fork-lift truck 10 includes a lifting mechanism 12, for lifting and carrying items such as pallets. The lifting mechanism 12 generally includes a pair of forks 15, which extend generally horizontally away from the fork-lift truck 10. In use, the forks 15 often scrape the ground or other surface, such as asphalt or cement, on which items to be lifted are present. Because of this repeated scraping, the forks 15 are damaged and frequently wear out.

Because the forks 15 carry the majority, if not all, of the weight of the item being lifted, worn out forks, or even forks that are slightly worn, are undesirable. To maintain the fork-lift truck 10 in proper working condition, worn forks are replaced when they become too thin and/or no longer meet set standards. Replacement of the forks is costly, due to the cost of the forks themselves, the cost of labor to replace the forks, and the time lost due to the fork-lift truck being out of service.

The present invention provides a replaceable wear guard for forks that inhibits the damage to forks.

### SUMMARY OF THE DISCLOSURE

The present disclosure is directed to a removable and replaceable wear guard for fork-lift truck forks. The wear guard increases the life of the forks by being a sacrificial part, thus decreasing the wear on the forks.

In one particular aspect, the invention is directed to a guard for positioning on a fork having bottom surface, a tip and a heel. The guard has a body configured to cover at least a portion of the bottom surface of the fork, with the body extending at least a portion of the length between the tip and the heel. An attachment mechanism for holding the body onto the fork is included. The attachment mechanism could be a pocket for receiving the tip of the fork, or a sleeve for passing the fork therethrough. The sleeve could encircle the fork. The body could extend the entire length of the fork from the top to the heel, and/or could extend around and engage the heel of the fork. The guard could be made from a polymeric material, and include metal, such as to increase the wear resistance.

In another particular aspect, the invention is directed to a guard for decreasing wear on a fork bottom surface. The guard has a body configured to cover at least a portion of the bottom surface of the fork, the body extending at least a portion of the length between the tip and the heel. An attachment mechanism, such as a pocket or a sleeve, holds the body onto the bottom surface. The body may extend around and engages the heel of the fork. The body, or any other portion of the guard, can be made from a polymeric material, and optionally include metal.

These and various other features which characterize the backpacks of this disclosure are pointed out with particularity in the attached claims. For a better understanding of the packs of the disclosure, their advantages, their use and objectives obtained by their use, reference should be made to the drawings and to the accompanying description, in which there is illustrated and described preferred embodiments of the invention of this disclosure.

### BRIEF DESCRIPTION OF THE DRAWINGS

FIG. 1 is a schematic rendering of a well-known fork-lift truck;

FIG. 1A is an enlarged perspective view of a fork from a fork-lift truck;

FIG. 2 is a perspective view of a first embodiment of a fork wear guard according to the present invention; and

FIG. 3 is a perspective view of a second embodiment of a fork wear guard according to the present invention.

### DETAILED DESCRIPTION

In general, the present invention is directed to a wear guard for a fork for a fork-lift truck. The wear guard is removable and replaceable on the fork, providing a ‘sacrificial part’ to wear, such as due to contact with the floor, rather than having the fork wear.

Referring now to the figures, where like reference numerals represent the same element throughout the various figures, various embodiments of the wear guard of the present invention are shown and described.

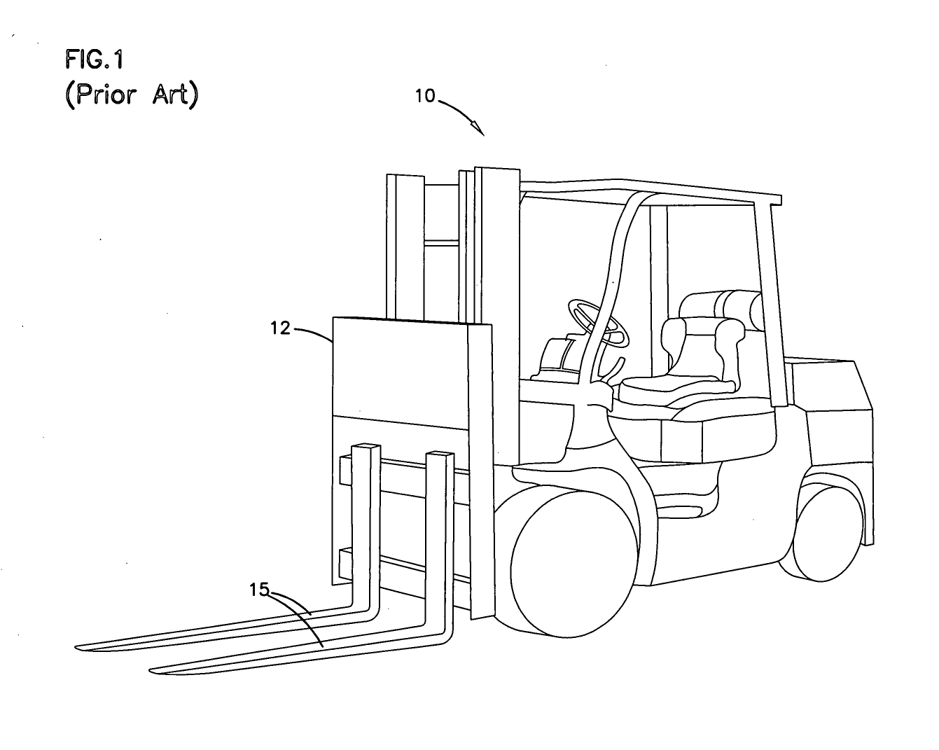

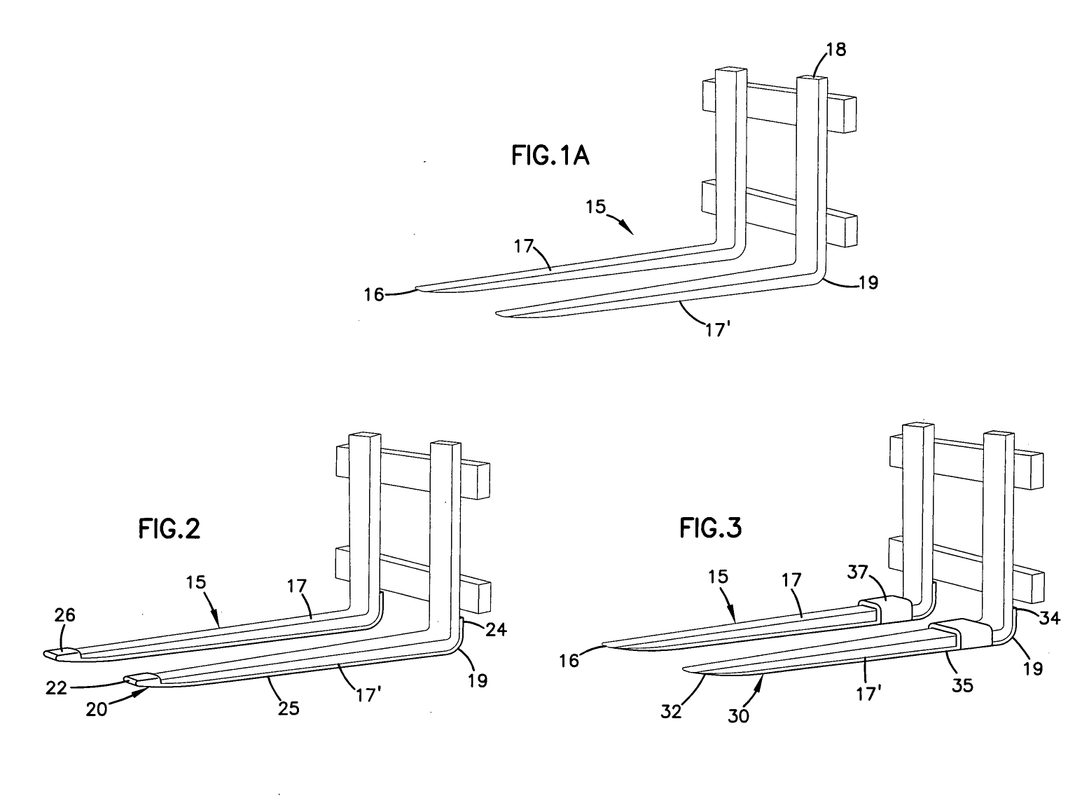

In FIG. 1, for purposes of clarity, a fork-lift truck 10 is generally illustrated. The fork-lift truck 10 is well known and various alternates are available, all which are suitable for use with the present invention.

The fork-lift truck 10 includes a lifting mechanism 12, for lifting and carrying items such as pallets of items. The lifting mechanism 12 generally includes a pair of forks 15, which extend generally horizontally away from the fork-lift truck 10. Various configurations for the forks 15 are known. The forks 15 may have a slight angle, to improve the seating of the carried items thereon. Generally, the forks 15 are steel, iron, or other strong and wear resistant material. Usually, the forks 15 are removably connected to the lifting mechanism 12. In use, the forks 15 often scrape the ground or other surface, such as cement, on which items to be lifted are present, causing repeated damage to the forks 15. Because of this repeated scraping, the forks 15 frequently wear out. Worn-out forks 15, or even forks 15 that are slightly worn, are undesirable. To maintain the fork-lift truck 10 in proper working condition, worn forks 15 are typically replaced when the damage reaches a preset threshold. The present invention provides a replaceable wear guard for forks 15 that inhibits the damage to forks 15, thus extending the life of the forks.

An enlarged view of the fork 15 is shown in FIG. 1A. Fork 15 has a first end 16 and an opposite second end 18. The first end 16 is transitioned to a tip, configured for sliding or otherwise moving under items, such as pallets, to be moved. The second end 18 is configured for attachment to the lifting mechanism 12. Extending between the first end 16 and the second end 18 is a generally horizontal portion 17, which includes a bottom surface 17′. Items to be moved are carried on the horizontal portion 17. Also, positioned between the first end 16 and the second end 18 is a heel 19, which is a transition between the generally horizontal portion 17 and the second end 18. It is typically the bottom surface 17′ and heel 19 that scrape or otherwise contact the ground when fork 15 is used; this is particularly the case when the tips 16 are angled up from the ground. In many fork designs, the heel 19 is the lowest point of the fork 15, and thus wears the most.

In FIG. 2, the fork 15 is illustrated having a wear guard 20 positioned thereon. Preferably, the guard 20 covers and protects at least a portion of the bottom surface 17′ and heel 19. In this embodiment, the guard 20 covers the entire bottom surface 17′, including the tip 16.

The guard 20 includes a first end 22, an opposite second end 24, and a body 25 extending therebetween. Preferably the body 25, having a generally uniform thickness, extends from the tip 16 of the fork 15 around the heel 19 and covers the bottom surface 17′. The body 25 may include a portion that extends up the lateral side of the horizontal portion 17, but generally, little if any wear of the fork 15 occurs on the sidewall.

The guard 20 includes a tip sleeve 26 configured to slip over and onto the first end 16 of the fork 15. The tip sleeve 26 secures the guard 20 to the first end 16 and inhibits the guard 20 from being pushed too far back toward the heel 19, as could happen when the fork 15, with the guard 20 mounted thereon, is slid across a floor when the fork-lift truck 10 moves forward. Although the tip sleeve 26 is illustrated as covering all of the tip 16, e.g., the tip sleeve 26 has a concave portion that forms a receiving pocket for the tip 16. It is understood that the tip sleeve 26 could have an opening so as to not completely cover or engulf the tip 16. At the second end 24, the guard 20 includes a portion that covers and preferably engages with the heel 19, for example, with a snapping action, to better secure the guard 20 to the fork 15. A portion of the guard 20 extends vertically toward the second end 24. The fork 15 or the guard 20 may include a structure to facilitate and/or improve engagement with the guard 20 at the second end 24.

Referring to FIG. 3, a second embodiment of a wear guard is shown as guard 30 on the fork 15. The guard 30 includes a first end 32, an opposite second end 34, and a body 35 extending therebetween. The body 35 extends and tapers from the tip 16 of the fork 15 to the heel 19 and covers the bottom surface 17′. That is, the thickness of the body 35 increases as it progresses from the first end 32 at the tip 16 to the second end 34 proximate the heel 19. The body 35 may include a portion that extends up the side of the horizontal portion 17, but generally little if any wear of the fork 15 occurs on the sidewall.

The guard 30 includes a sleeve 37 that extends around the horizontal portion 17 from one side to the other of the body 35, encircling the horizontal portion 17. The sleeve 37 is configured to pass over the horizontal portion 17 and retain the guard 30 onto the horizontal portion 17. In an alternate construction, the sleeve may be a partial sleeve, not completely encircling the horizontal portion 17. Although the sleeve 37 is positioned closer to the heel 19 than to the tip 16 in FIG. 3, it is understood that the sleeve 37 could be positioned at generally any location between the tip 16 and the heel 19. The guard 30 also includes a portion that engages with the heel 19, for example, with a snapping action, to better secure the guard 30 to the fork 15.

The body 25, 35 of the guard 20, 30 is preferably sufficiently thick so that the body 25, 35 does not wrinkle, buckle or the like, due to contact with a floor surface. The body 25, 35 should also be sufficiently thick so that the guard 20, 30 does not wear too quickly but has a sufficient life.

The guard 20, 30, and another other embodiments that are within the scope of this invention, can be made from any suitable material including plastic (polymeric material), metal, wood, composite materials, and any combination of these materials. Polymeric materials, such as polyethylene, polypropylene, and polycarbonate, are preferred materials, due to their cost and ease of molding to the desired shape. Metal edges or reinforcing structures, such as steel, may be included in plastic guards to extend the life thereof and increase the strength of the guards. Any materials, such as metal, may be added to plastic guards during the molding process, so that the metal is integral with the polymeric material, or can be added after the molding is completed. The guard 20, 30 may include a treatment or an additive, such as to polymeric materials, to decrease the friction between the guard 20, 30 and any surface on which it would slide, such as concrete.

It is understood that various alternate designs of the guard 20, 30 are feasible and still remain within the scope of the invention. For example, guard 20, 30 could be configured to extend short of the tip 16 of the fork 15. As another alternative, the tip sleeve 26 or sleeve 37 could be designed to extend generally the entire length of the fork 15, from the first end 16 to the heel 19. The tip sleeve 26 or sleeve 37 could extend vertically to the second end 18 of the fork 15. As another example, both a tip sleeve 26 and a sleeve 37 could be present on a wear guard.

The features described for the guard 20 could be used in conjunction with features of the guard 30, and visa versa. For example, the body 25 could taper, rather than be uniform, from the tip 16 to the heel 19.

Additionally, the guard 20, 30, or alternate embodiments, could be used for permanent or replaceable forks on other equipment, such as hand-pallet trucks, walkie-pallet trucks, walkie-stacker trucks, dollies, or other either motorized or non-motorized lifting apparatuses.

The guard 20, 30, and any other embodiments, are readily removable and replaceable onto the fork 15. As the guard 20, 30 wears to an unacceptable level, the used guard 20, 30 can be removed from the fork 15 and replaced with a new guard 20, 30. Preferably, the removal and installation process can be done without the use of tools. Preferably also, the removal and installation of the guard 20, 30 can be done with the fork 15 attached to the lifting mechanism 12. The use of the guard 20, 30, or other embodiment, extends the life of fork 15 by lowering and preferably eliminating wear of the forks 15 due to contact with a floor. The wear guard 20, 30 acts as a sacrificial part, with the guard 20, 30 being damaged and worn rather than the more expensive fork 15.

The guard 20, 30 could also be fastened in some way to the fork 15, for example, by an adhesive, bolt, screw, or some other adhering or fastening means. In an alternate embodiment using an adhesive, the guard may not include a sleeve 37 or a tip sleeve 26.

It is to be understood, however, that even though numerous characteristics and advantages of the present invention have been set forth in the foregoing description, together with details of the structure and function of the invention, the disclosure is illustrative only, and changes may be made while remaining within the principles of the invention.

What is claimed:

1. A guard for positioning on a fork having a bottom surface, a tip and a heel, the guard comprising:
(a) a body configured to cover at least a portion of the bottom surface of the fork, the body extending at least a portion of the length between the tip and the heel; and
(b) an attachment mechanism for holding the body onto the fork.

2. The guard of claim 1, wherein the attachment mechanism defines a pocket for receiving the tip of the fork.

3. The guard of claim 1, wherein the attachment mechanism is a sleeve for passing the fork therethrough.

4. The guard of claim 3, wherein the sleeve encircles the fork.

5. The guard of claim 1, wherein the body extends around and engages the heel of the fork.

6. The guard of claim 1, wherein the body comprises a polymeric material.

7. The guard of claim 6, wherein the body further comprises metal.

8. A guard for decreasing wear on a fork bottom surface, the guard comprising:
(a) a body configured to cover at least a portion of the bottom surface of the fork, the body extending at least a portion of the length between the tip and the heel; and
(b) an attachment mechanism for holding the body onto the bottom surface.

9. The guard of claim 8, wherein the body extends around and engages the heel of the fork.

10. The guard of claim 8, wherein the body comprises a polymeric material.

11. The guard of claim 10, wherein the body further comprises metal.

12. The guard of claim 8, wherein the attachment mechanism defines a pocket for receiving the tip of the fork.

13. The guard of claim 8, wherein the attachment mechanism is a sleeve for passing the fork therethrough.

14. The guard of claim 13, wherein the sleeve encircles the fork.
